(19) United States
(12) Patent Application Publication
(10) Pub. No.: US 2026/0133325 A1
(43) Pub. Date: May 14, 2026

(54) RECEPTION DEVICE, RECEPTION METHOD, AND RECEPTION PROGRAM

(71) Applicant: Furuno Electric Co., Ltd., Nishinomiya-City (JP)

(72) Inventors: Kazuaki IMAOKA, Hiroshima (JP); Takaki TOMINAGA, Amagasaki (JP)

(73) Assignee: Furuno Electric Co., Ltd., Nishinomiya-City (JP)

(21) Appl. No.: 19/437,393

(22) Filed: Dec. 31, 2025

Related U.S. Application Data
(63) Continuation of application No. PCT/JP2024/024837, filed on Jul. 9, 2024.

(30) Foreign Application Priority Data
Jul. 14, 2023 (JP) 2023-116320

(51) Int. Cl. G01S 19/33; G01S 19/37

(52) U.S. Cl. CPC G01S 19/33; G01S 19/37

(57) ABSTRACT

A receiver includes an antenna and processing circuitry. The antenna receives the satellite signals from each of the plurality of satellite systems in a multi-GNSS positioning using the plurality of satellite systems. The processing circuitry estimates a time error of the antenna for each of the plurality of satellite systems. The time error of the antenna is estimated based on the system time of each of the plurality of satellite systems. The system time of each of the plurality of satellite systems is based on the satellite signals received from each of the plurality of satellite systems.

### CROSS-REFERENCE TO RELATED APPLICATION(S)

This application is a bypass continuation of International Application No. PCT/JP2024/024837, filed on Jul. 9, 2024, which claims priority to Japanese Patent Application No. 2023-116320, filed on Jul. 14, 2023. The entire contents of the above applications are incorporated herein by reference.

### TECHNICAL FIELD

The present disclosure relates to a reception device, a reception method, and a reception program.

### BACKGROUND

Conventionally, there have been known technologies for performing a multi-GNSS (Global Navigation Satellite System) positioning by combining multiple satellite systems such as GPS (Global Positioning System), Galileo, BeiDou System (BDS), and Quasi-Zenith Satellite System (QZSS) for automobiles, ships, etc.

### SUMMARY

In each of the above-mentioned satellite systems, each organization in each country managing the system manages the satellite at its own system time. Therefore, there may be an error in the system time among the satellite systems. This time error may reduce the positioning accuracy of the multi-GNSS positioning.

In this regard, for example, a method for estimating the time error with the system time of another satellite system based on the system time of a specific satellite system may be considered.

However, in the above method, when a satellite signal from a reference satellite system cannot be received, the estimation of the time error becomes difficult, and the positioning accuracy may be degraded.

Therefore, in the present disclosure, we propose a reception device, a reception method, and a reception program that can realize a high-precision positioning without requiring a reference satellite system.

To solve the problems described above, the reception device, according to one aspect of the present disclosure, comprises an antenna and an estimation module. The antenna receives satellite signals from each of the plurality of satellite systems in a multi-GNSS positioning using the plurality of satellite systems. The estimation module estimates a time error of the antenna for each of the plurality of satellite systems. The time error of the antenna is estimated based on the system time of each of the plurality of satellite systems. The system time of each of the plurality of satellite systems is based on the satellite signals received from each of the plurality of satellite systems.

Thus, the reception device can realize a high-precision positioning without requiring a reference satellite system.

The time error of the antenna, according to the present disclosure, also includes the time error included in an internal time of the reception device and a time error between the plurality of satellite systems.

Thus, the reception device can realize the high-precision positioning without being affected by the time error between the satellite systems.

When the number of the plurality of satellite systems is n (n is a natural number), the estimation module estimates the time error of the antenna based on the n+3 or more of the satellite signals.

Thus, the reception device can estimate the time error and perform the positioning operation by receiving the number of satellite signals corresponding to the number of satellite systems.

When the number of the plurality of satellite systems is n (n is a natural number) and the total number of satellites in the plurality of satellite systems is less than a predetermined number, the estimation module estimates a time error of the antenna based on the n+2 of the satellite signals by using any two-dimensional position information among the three-dimensional position information as a variable and the remaining one-dimensional position information as a fixed value.

Thus, the reception device can estimate the time error and perform the positioning operation even when the number of received satellite signals is small.

In addition, the estimation module, according to the present disclosure, estimates the time error of the antenna based on a position information indicating a height position where the antenna is located as a fixed value.

Thus, the reception device can estimate the time error while suppressing the deviation between the result of the positioning operation and the position of the actual reception device.

When the number of the plurality of satellite systems is n (n is a natural number) and the position information is known, the estimation module estimates the time error of the antenna based on the n or more satellite signals using the three-dimensional position information as a fixed value.

Thus, the reception device can estimate the time error and perform the positioning operation even when the number of received satellite signals is small.

In addition, the estimation module, according to the present disclosure, estimates the time error of the antenna using the three-dimensional position information indicating the three-dimensional position where the antenna is located as a fixed value.

Thus, the reception device can estimate the time error and perform the positioning operation even when the number of received satellite signals is small.

The estimation module estimates the time error of the antenna using the three-dimensional position input from an outside (user input) as a fixed value.

Thus, the reception device can estimate the time error and perform the positioning operation even when the number of received satellite signals is small.

The estimation module, according to the present disclosure, also estimates the time error of the antenna and performs a positioning operation using an observation model including a time error of the antenna as a variable.

Thus, the reception device can realize the high-precision positioning without requiring a reference satellite system.

The reception method, according to one more aspect, of the present disclosure, is a reception method executed by the reception device and includes a receiving step of receiving satellite signals from each of the plurality of satellite systems in a multi-GNSS positioning using the plurality of satellite systems, and an estimating step of estimating a time error of the antenna based on the system time of each of the plurality of satellite systems. The system time of each of the plurality of satellite systems is based on the satellite signals received from each of the plurality of satellite systems.

Thus, the reception method can realize the high-precision positioning without requiring a reference satellite system.

Further, the reception program, according to one more aspect of the present disclosure, causes a computer (processing circuitry) to execute a reception procedure (operation) for receiving satellite signals from each of the plurality of satellite systems in multi-GNSS positioning using the plurality of satellite systems, and an estimation procedure for estimating a time error of the antenna based on the system time of each of the plurality of satellite systems. The system time of each of the plurality of satellite systems is based on the satellite signals received from each of the plurality of satellite systems.

Thus, the reception method can realize the high-precision positioning without requiring a reference satellite system.

### BRIEF DESCRIPTION OF DRAWINGS

FIG. 1 is a diagram for explaining a reception method according to an embodiment.

FIG. 2 is a block diagram showing a configuration of a reception device according to the embodiment.

FIG. 3 is a flowchart showing a processing procedure of a process executed by the reception device according to the embodiment.

### DESCRIPTION OF EMBODIMENTS

The embodiments of the present invention will now be described with reference to the drawings. In the present specification and the figures, elements like those described above with respect to the previous figures may be denoted by the same reference numerals, and detailed descriptions may be omitted accordingly. In addition, at least one of the following embodiments may be optionally combined.

The present disclosure relates to a technology for performing a multi-GNSS positioning using a plurality of satellite systems. The plurality of satellite systems includes satellite systems such as Global Positioning System (GPS), Galileo, BeiDou System (BDS), GLONASS, Quasi-Zenith Satellite System (QZSS), etc., where each country operates its own satellite.

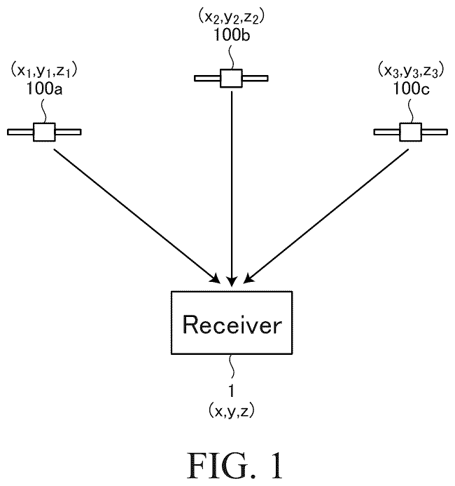

In the present disclosure, by executing a reception method according to an embodiment, a time error included in an observation model of a pseudo distance between a reception device and the satellite, and the time error of the reception device relative to the system time based on each satellite system, is estimated. The reception method according to an embodiment will now be described in detail with reference to FIG. 1.

FIG. 1 is a diagram for explaining a reception method according to the embodiment. In FIG. 1, a reception device 1 receives satellite signals from three satellites 100a, 100b, and 100c having different satellite systems, and performs positioning. In FIG. 1, three-dimensional coordinates consisting of an X axis, a Y axis, and a Z axis as a position information of the three satellites 100a, 100b, and 100c and the reception device 1 are shown.

Although FIG. 1 shows an example of receiving satellite signals from one satellite in a satellite system, in practice, satellite signals are received from multiple satellites in the satellite system. If the three satellites 100a, 100b, and 100c are not specifically distinguished, they may be collectively referred to as a satellite 100.

The reception device 1 performs a positioning based on a satellite signal received from the satellite 100. Specifically, the reception device 1 calculates a pseudo distance between the satellite 100 and the reception device 1 for each satellite signal by applying a speed of light to a difference between the transmission time of the satellite signal by the satellite 100 and a reception time of the satellite signal by the reception device 1.

The reception device 1 estimates its own three-dimensional coordinates by using the observation model, which includes its own three-dimensional coordinates as variables, which is the observation model of the pseudo distance. Specifically, the reception device 1 determines the equations of the observation model for each pseudo distance of the calculated satellite signal and estimates the three-dimensional coordinates as variables by solving the simultaneous equations using each equation.

Here, in the multi-GNSS positioning, in the observation model of the pseudo distance described above, the time error included in an internal time of the reception device 1 (an internal time error) and the time error of a system time between the plurality of satellite systems (intersystem time errors, ISB: Inter System Bias) are included as variables.

This inter-system time error is caused by a deviation of the respective system time because each organization managing the system manages the satellite at its own system time. If this inter-system time error cannot be accurately estimated, the positioning accuracy of the multi-GNSS positioning may deteriorate.

In this regard, for example, a method for estimating the time error with the system time of another satellite system based on the system time of a specific satellite system may be considered. Specifically, when the system time of the GPS is used as a reference, the time error of the system time is set to zero (that is, only the internal time error is included as a variable.) in the observation model of the satellite signal of the GPS, and the time error of the system time of the Galileo is included as a variable in the observation model of the satellite signal of the Galileo with respect to the system time of the GPS (that is, the internal time error and the system time error are included as variables.). In this method, if the satellite signal of the GPS as a reference can be received, the internal time error and the system time error can be estimated by the above simultaneous equations.

However, in the above method, if the satellite signal of the satellite system of the GPS as the reference cannot be received, for example, the observation model of the GPS cannot be obtained, the estimation of the inter-system time error becomes difficult, and the positioning accuracy deteriorates.

Therefore, the reception method, according to an embodiment, performs positioning without requiring a reference satellite system. Specifically, the reception method, according to the embodiment, estimates the time error of the reception device 1 based on the system time of each of the plurality of satellite systems.

More specifically, the reception device 1 sets the time error of the reception device 1 based on the respective system time as a variable, as shown by the observation models of Equations (1) and (2) below. Specifically, Equation (1) is an observation model when the satellite system is the GPS, and Equation (2) is an observation model when the satellite system is the Galileo. In Equations (1) and (2), ρⁿ is a pseudo distance, xⁿ, yⁿ, and zⁿ are three-dimensional coordinates of the satellite 100, and x, y, and z are three-dimensional coordinates of the reception device 1. b_{GPS} is the time error of the reception device 1 with respect to the system time of GPS, and b_{Galileo} is the time error of the reception device 1 with respect to the system time of Galileo. En is the observation error. n is the number identifying the satellite.

$${ρ}^{n} = \sqrt{{( {x}^{n} - x )}^{2} + {( {y}^{n} - y )}^{2} + {( {z}^{n} - z )}^{2}} - {b}_{GPS} + {ϵ}^{n} \qquad ( 1 )$$

$${ρ}^{n} = \sqrt{{( {x}^{n} - x )}^{2} + {( {y}^{n} - y )}^{2} + {( {z}^{n} - z )}^{2}} - {b}_{Galileo} + {ϵ}^{n} \qquad ( 2 )$$

In Equations (1) and (2) of the observation model, ρⁿ, xⁿ, yⁿ, and zⁿ are known values, and X, y, z, b_{GPS}, b_{Galileo} are unknown values. That is, the reception device 1 estimates the unknown values x, y, z, b_{GPS}, b_{Galileo} by the simultaneous equations.

Further, b_{GPS}, b_{Galileo} are the time errors, including time errors, included in the internal time (clock frequency) of the reception device 1 and the time errors (time errors with other satellite systems, ISB) between a plurality of satellite systems. In other words, b_{GPS} and b_{Galileo} are the variables obtained by synthesizing the variable of time error included in the internal time of the reception device 1 and the variable of the time error between the plurality of satellite systems.

In other words, in the present disclosure, the reception device 1 does not separately estimate the time error included in the internal time of the reception device 1 and the time error between the plurality of satellite systems, but estimates the time error obtained by combining the respective time errors.

For example, when the number of satellite systems is two (the GPS and the Galileo), the reception device 1 estimates the five unknown values of x, y, z, b_{GPS}, and b_{Galileo} by the simultaneous equations using the five satellite signals. Note that every time the number of satellite systems increases by one, the time error b increases by one, so the number of satellite signals required also increases by one. The reception device 1 may use five or more satellite signals when estimating the five unknown values.

That is, when the number of the plurality of the satellite systems is n (n is a natural number), the reception device 1 estimates the time error (b_{GPS}, b_{Galileo}) of the reception device 1 based on the n+3 or more satellite signals.

Since the five satellite signals need to include at least one satellite signal of each satellite system, the five satellite signals can be configured in various patterns, such as a case including the four GPS satellite signals and one Galileo satellite signal, or a case including the three GPS satellite signals and the two Galileo satellite signals.

When the number of satellites 100 that have received satellite signals from the plurality of satellite systems is less than a predetermined number, the reception device 1 may perform the position estimation using any one of the three-dimensional coordinates of the reception device 1 as a fixed value.

For example, when the number of satellite systems is two and the z-axis coordinate (height) is set as a fixed value, the reception device 1 estimates the four unknown values of x, y, b_{GPS}, and b_{Galileo} by the simultaneous equations using the four satellite signals.

In other words, the reception device 1 estimates the time error of the reception device 1 based on n+2 satellite signals using any two-dimensional coordinate among the three-dimensional coordinates as a variable and the remaining one-dimensional coordinate as a fixed value. Thus, the time error can be estimated even if the number of the received satellite signals is less than a predetermined number (for example, less than n+3).

In addition, it is preferable that the coordinate to be fixed is the height position (z-axis coordinate). This is because the height position of an automobile or a ship to which the reception device 1 is mounted does not change significantly. The reception device 1 may prohibit setting the height position as a fixed value when the height position from the current time to a predetermined period ago has changed by a threshold value or more.

The reception device 1 may estimate the time error by using the three-dimensional position information of the x, y, and z as fixed values. For example, when the number of the plurality of satellite systems is n (n is a natural number) and the position information is known, the reception device 1 estimates the time error of the reception device 1 based on the n or more satellite signals by using the three-dimensional position information as a fixed value. For example, when the number of satellite systems is two (for example, the GPS and the Galileo), the reception device 1 estimates the two unknown values of b_{GPS} and b_{Galileo} by the simultaneous equations using the two satellite signals. In this case, the position information at the time of the previous positioning or the position information input from the outside is used. The position information input from the outside is the position information positioned by another system or the position information input manually by the user.

Since different observation errors εⁿ exist for each satellite signal in the observation model, the reception device 1 estimates the three-dimensional coordinates and the time error (b_{GPS}, b_{Galileo}) estimated from each satellite signal to be most certain by using, for example, a mathematical method such as a least squares method or a Kalman filter.

Thus, the reception device 1 according to the embodiment does not need to use a specific satellite system as a reference and estimates the time error of the reception device 1 based on the system time of each satellite system.

Thus, even when the satellite signal cannot be received from the satellite of one of the satellite systems among the plurality of satellite systems, it is possible to estimate the time error with the reception device 1 of another satellite system that has received the satellite signal. That is, the reception device 1 can realize a high-precision positioning without requiring a reference satellite system.

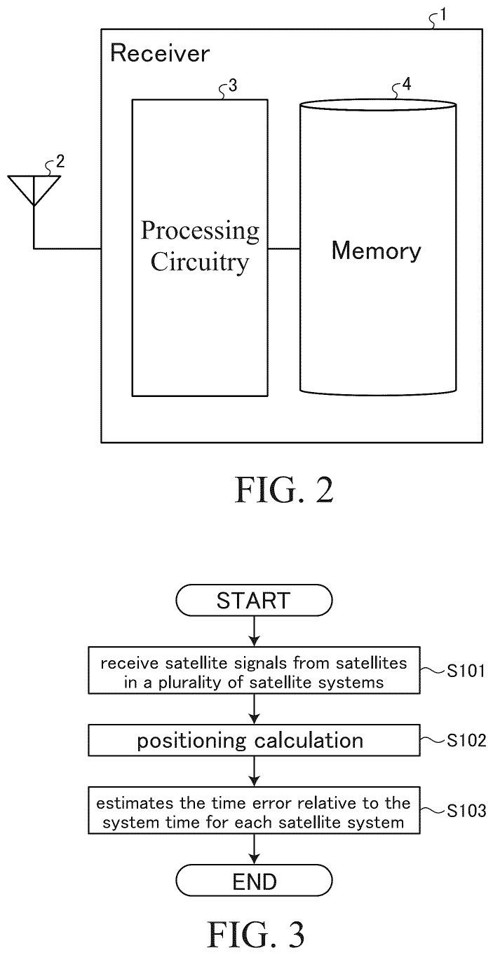

Next, a configuration example of the reception device 1 according to the embodiment will be described with reference to FIG. 2. FIG. 2 is a block diagram showing a configuration of a reception device (receiver) 1 according to the embodiment. As shown in FIG. 2, the reception device (receiver) 1 includes an antenna 2, a controller (processing circuitry, or an estimation module) 3, and a memory (storage module) 4.

The antenna 2 is a receiver antenna for receiving satellite signals. The antenna 2 receives satellite signals transmitted from satellites of a plurality of satellite systems.

The processing circuitry 3 is a controller, a CPU, a processor, and a processing circuitry, which is realized by executing various programs (equivalent to an example of an information processing program) stored in a storage device inside the reception device 1 using RAM or the like as a work area by a processor such as a CPU (Central Processing Unit) or an MPU (Micro Processing Unit). The processing circuitry 3 may also be a controller, which may be realized by an integrated circuit such as an ASIC (Application Specific Integrated Circuit), an FPGA (Field Programmable Gate Array), or a GPGPU (General Purpose Graphic Processing Unit).

The processing circuitry 3 performs processing such as the position calculation and the time error estimation using the observation models for each satellite system, such as Equation (1) and Equation (2). The processing circuitry 3 outputs the positioning results estimated by the positioning calculation to an external device (not shown). The processing circuitry 3 corresponds to the estimation module in the present disclosure.

The memory (storage module) 4 is realized by, for example, a semiconductor memory element such as a RAM (Random Access Memory) or a flash memory (Flash Memory), or a storage device such as a hard disk or an optical disk.

Next, with a reference to FIG. 3, a processing procedure of the processing executed by the reception device 1 according to the embodiment will be described. FIG. 3 is a flowchart showing a processing procedure of a process executed by the reception device 1 according to the embodiment.

As shown in FIG. 3, the reception device 1 receives satellite signals from satellites in a plurality of satellite systems (step S101).

Next, the reception device 1 performs the positioning calculation using the received satellite signals (step S102). Specifically, the reception device 1 calculates the pseudo-distance and estimates the three-dimensional coordinates of the reception device 1 by the simultaneous equations using the pseudo-distance and the observation model. The reception device 1 estimates the three-dimensional coordinates estimated from each satellite signal so as to minimize the error by using a mathematical method such as, for example, the least squares method or the Kalman filter.

Subsequently, the reception device 1 estimates the time error relative to the system time for each satellite system by substituting the estimated three-dimensional coordinates into the observation model (step S103), and the processing is completed.

As described above, according to the embodiment of the present disclosure, the reception device 1 includes the antenna 2 and the processing circuitry 3. In the multi-GNSS positioning using a plurality of satellite systems, the antenna 2 receives satellite signals from each of the plurality of the satellite systems. The processing circuitry 3 estimates the time error of the antenna 2 for each of the plurality of satellite systems based on the system time of each of the plurality of satellite systems. The system time of each of the plurality of satellite systems is based on the satellite signals received from each of the plurality of satellite systems. Thus, the reception device 1 can estimate the time error with the antenna 2 in the other satellite system that has received the satellite signal even when the satellite signal cannot be received from the satellite of one of the satellite systems among the plurality of satellite systems. That is, the reception device 1 can realize high-precision positioning without requiring a reference satellite system.

In addition, the present invention is not limited to the above embodiment, and various modifications can be made within the scope of the claim. For example, a form obtained by suitably combining the above embodiments in an area where the contents are consistent is also included in the technical scope of the present invention.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few:

Conditional language such as, among others, “can”, “could”, “might” or “may” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures. should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations” without other modifiers, typically means at least two recitations, or two or more recitations).

It will be understood by those within the art that, in general, terms used herein, are generally intended as “open” terms (e.g., the term “including” should be interpreted as “including but not limited to” the term “having” should be interpreted as “having at least” the term “includes” should be interpreted as “includes but is not limited to” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface.” The term “vertical” refers to a direction perpendicular to the horizontal as just defined. Terms such as “above”, “below”, “bottom”, “top”, “side”, “higher”, “lower”, “upper”, “over” and “under” are defined with respect to the horizontal plane.

As used herein, the terms “attached”, “connected”, “mated” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about” and “substantially” as used herein include the recited numbers, and also represent an amount close to the stated amount that still performs a desired function or achieves a desired result. For example, the terms “approximately”, “about” and “substantially” may refer to an amount that is within less than 10% of the stated amount. Features of embodiments disclosed herein preceded by a term such as “approximately”, “about” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### REFERENCE SIGNS LIST

1: Receiver (Reception Device), 2: Antenna, 3: Controller (Processing Circuitry/Estimation Module), 4: Memory (Storage Module), 100 (100a, 100b, 100c): Satellite

What is claimed is:

1. A receiver comprising:
an antenna configured to receive the satellite signals from each of the plurality of satellite systems in a multi-GNSS positioning using the plurality of satellite systems; and
processing circuitry configured to estimate a time error of the antenna for each of the plurality of satellite systems based on the system time of each of the plurality of satellite systems, wherein:
the system time of each of the plurality of satellite systems is based on the satellite signals received from each of the plurality of satellite systems.

2. The receiver according to the claim 1, wherein:
the time error of the antenna includes a time error included in an internal time of the receiver and a time error between the plurality of satellite systems.

3. The receiver according to the claim 2, wherein:
the processing circuitry is further configured to estimate the time error of the antenna based on the n+3 or more of the satellite signals
when the number of the plurality of satellite systems is n (where n is a natural number).

4. The receiver according to the claim 3, wherein:
the processing circuitry is further configured to estimate the time error of the antenna based on
n+2 of the satellite signals by using any two-dimensional position information among a three-dimensional position information as a variable and
the remaining one-dimensional position information as a fixed value
when the number of the plurality of satellite systems is n (n is a natural number) and the total number of satellites in the plurality of satellite systems is less than a predetermined number.

5. The receiver according to the claim 4, wherein:
the processing circuitry is further configured to estimate the time error of the antenna based on a position information indicating a height position
where the antenna is located as a fixed value.

6. The receiver according to the claim 5, wherein:
the processing circuitry is further configured to estimate the time error of the antenna based on the n or more satellite signals using the three-dimensional position information as a fixed value
when the number of the plurality of satellite systems is n (where n is a natural number) and the position information is known.

7. The receiver according to the claim 6, wherein:
the processing circuitry is further configured to estimate the time error of the antenna using the three-dimensional position information indicating the three-dimensional position
where the antenna is located as a fixed value.

8. The receiver according to the claim 7, wherein:
the processing circuitry is further configured to estimate the time error of the antenna using a three-dimensional position input from an outside as a fixed value.

9. The receiver according to the claim 8, wherein:
the processing circuitry is further configured to estimate the time error and to perform a positioning operation using an observation model including a time error of the antenna as a variable.

10. A reception method executed by a receiver, comprising:
receiving the satellite signals from each of the plurality of satellite systems in a multi-GNSS positioning using the plurality of satellite systems; and
estimating a time error of the antenna based on the system time of each of the plurality of satellite systems, wherein
the system time of each of the plurality of satellite systems is based on the satellite signals received from each of the plurality of satellite systems.

11. A non-transitory computer-readable medium storing instructions that, when executed by processing circuitry, cause the processing circuitry to perform a reception operation comprising:
receiving the satellite signals from each of the plurality of satellite systems in a multi-GNSS positioning using the plurality of satellite systems; and
estimating a time error of the antenna based on the system time of each of the plurality of satellite systems, wherein
the system time of each of the plurality of satellite systems is based on the satellite signals received from each of the plurality of satellite systems.
